(19) United States
(12) Patent Application Publication
(10) Pub. No.: US 2009/0153306 A1
(43) Pub. Date: Jun. 18, 2009

(54) Security System

(76) Inventor: Anatoli Stobbe, Barsinghausen (DE)

Correspondence Address: COLLARD & ROE, P.C., 1077 NORTHERN BOULEVARD, ROSLYN, NY, 11576, US

(21) Appl. No.: 12/083,280

(22) PCT Filed: Nov. 27, 2006
(86) PCT No.: PCT/DE2006/002095

§ 371 Date: Apr. 8, 2008

(30) Foreign Application Priority Data
Nov. 28, 2005 (DE) 10 2005 056 854.8

(51) Int. Cl. H04Q 5/22; G06F 13/38

(52) U.S. Cl. 340/10.31; 340/825

(57) ABSTRACT

The invention relates to a security system consisting of at least two security modules that are connected to a network and transmit data via the network. At least one of the security modules can be switched into an energy-saving mode by a first local event, an idle command generated by the first local event, or an idle command transmitted by another security module and into an operating mode by a second local event, a wake-up command generated by the second local event, or a wake-up command transmitted by another security module.

The invention relates to a security system according to the preamble of claim 1.

Security systems are used to allow, to block or to monitor the access and sojourn of persons in and/or to security-relevant areas and to also monitor the security-relevant areas with regard to sabotage, fire or moisture.

A security system consists of at least one security module which may be furnished with or connected to different sensors or peripheral devices, depending on the security standard. Furthermore, in accordance with requirements with respect to manipulation security, redundancy security and sabotage security, there may be a subdivision into multiple security modules, which communicate with one another and are interconnected for this purpose. The security modules may be connected to a network or a databus, so that data can be transmitted and exchanged over the network or databus.

The usual interfaces such as RS 232, RS 422, RS 485, USB, Ethernet and transmission protocols such as IEEE 802.LAN/WAN may be used for the data transmission for the purpose of compatibility of the security modules with one another and compatibility of the security modules with existing installations and communication media and to ensure and verify uniform security standards. Complex communications taking place according to the ISO/OSI reference model require high data rates of 100 Mbps as the current standard with a typically high data volume. Fast interfaces and fast processors must be used to be able to do justice to the demands made of these security standards, interfaces, transmission protocols regarding the data volume to be transmitted and the data rates. However, operation thereof necessitates a high energy demand.

To cover this energy demand, a conventional approach would consist of connecting all the spatially disparate security modules to a conventional power supply system via a separate power pack. However, then all the security modules would have to have suitable power packs, which would increase the number of circuit components and would increase the housing volume as well as the manufacturing costs of the security module.

However, an important prerequisite for such an approach would be that the conventional power supply network is available wherever the security modules are installed. However, this is not always the case, nor is it even possible for technical and economic reasons or for security reasons. In many cases, only signal lines that are designed and approved for transmission of low electric power to the security modules can be installed.

Even with a power supply via a network cable, e.g., POE (power over Ethernet), only a low electric power of up to 12 watts can be transmitted. When connecting modules to network cables, cost-intensive and circuitry-intensive measures must also be taken to prevent overspill and propagation of interference signals, so a restriction to just one or a few connections to a local or global network is to be desired.

The object of the invention is to reduce the power demand of a security system comprising fast and powerful processors and interfaces without any sacrifice in terms of security.

The object is achieved with a security system according to the preamble of claim 1 through the features of this claim 1.

Advantageous embodiments and refinements are derived from the dependent claims.

The present invention is based on the consideration that the security modules need not process and transmit data without interruption but instead must process and transmit data only in the case when security-relevant data must be detected, processed and transmitted. By analysis, differentiation and discrimination between events that require detection, processing and transmission of data and events that do not require detection, processing and transmission of data, the security modules can be switched between an energy-saving mode and an operating mode and thus the overall energy demand can be reduced in comparison with a constant operating mode of the security modules.

This also results in other advantages. The capacity of an emergency power supply can be reduced or the lifetime of an emergency power supply of a given capacity can be increased. Furthermore, power may be supplied to the security modules via another medium than a conventional power supply network, e.g., over signal lines, low-voltage lines which carry the operating voltage of the security modules, usually 12 volts, directly over an existing network or autarchically from the environment. In addition, the thermal load on components of the security modules which have a high power consumption in the operating mode is reduced and their lifetime is prolonged.

The first local event which puts one or more security modules in a energy-saving mode may be data inactivity or a disturbance in the power supply or a first time event.

Data inactivity occurs, for example, when no data that must be detected, processed and relayed are being received by other security modules or sensors or peripheral devices of the security module.

A disturbance in the power supply may occur when, for example, a central power source fails and an emergency power supply of a limited capacity goes on-line or when the capacity of a regular internal power supply or emergency power supply drops below a limit level.

A first time event may occur when, at the end of a data activity, no new data activity occurs after a preselected period of time has elapsed or access is blocked in general at certain times such as weekends, holidays and nighttimes.

In addition, the idle command transmitted by another security module can be generated by a first local event of the other security module.

This makes it possible to put security modules in an energy-saving mode not only through a local event but also by remote control through other security modules, which in turn analyze a first local event.

The second local event which puts the security module in an operating mode may be an activity of a sensor or a peripheral device connected to the security module or a data activity or a normalization of the power supply or a second time event.

An activity of a sensor or a peripheral device connected to the security module may consist of the fact that physical quantities or other criteria which must be analyzed, processed and optionally relayed by the security module are detected by the sensor or the peripheral device. It is assumed here that the sensors or peripheral devices are constantly in standby mode. Thus a concrete application consists of a proof of authorization in the form of a non-contact machine-readable data medium being brought into the reading area of a peripheral device designed as a reader.

Data activity may consist of data that must be detected, processed and optionally relayed being pending on a databus or a network after an idle state.

Normalization of the power supply may consist of the fact that a central power supply is again available and thus an emergency operation with limited capacity can be terminated.

A second time signal may consist of the fact that after an idle phase, signals from sensors or peripheral devices are again monitored to analyze, process and optionally relay physical quantities or other information altered in the meantime or to reactivate an access system after the end of holidays, weekends or nighttimes.

In the case of a sensor or a peripheral device that is separated spatially from the security module, the sensor or the peripheral device or the security module may comprise a transmission link having at least one additional or modified control transmitter and at least one additional or modified control receiver for transmitting a wake-up command from the sensor or the peripheral device to the security module.

Therefore, bypassing a constant energy-intensive transmission link, e.g., with conventional interface modules over a bus or over a network, the security module or the sensor or the peripheral device can be put in an operating mode via a special transmission link designed for a low operating power and then the communication between the sensor or the peripheral device and the security module takes place via the conventional transmission link, namely a databus or a network provided for data transmission.

In addition, the wake-up command transmitted by another security module may be generated by a second local event of the other security module.

Here again, a security module can be put in an operating mode by remote control by another security module, whereby a local event of the other security module is the causative factor here.

For transmission of the wake-up command from one security module to the other, the security modules may comprise a transmission link having at least one control transmitter and at least one control receiver.

It is likewise possible in this way to transmit a wake-up signal in a energy-saving mode via a special transmission link designed for a low operating power and to put the security modules in an operating mode, bypassing the energy-intensive transmission link between the security module with the network or databus and the interface modules, whereupon the rapid data transmission then takes place over the existing network or the databus with the interface modules.

The sensor connected to the security module may be a motion sensor or an electrostatic sensor or a capacitive sensor or a magnetic sensor or an electromagnetic sensor or a voltage sensor or a current sensor or a radar sensor or a pressure sensor or an acceleration sensor or a proximity sensor or an optical sensor or an acoustic sensor or a thermal sensor or a humidity sensor or a biometric sensor or a gas sensor or a fire sensor or a smoke sensor or a glass breakage sensor or a Hall sensor or a reed sensor or a switch.

Depending on the security requirements made of the security system, a wide variety of physical quantities and the events derived therefrom can thus be detected and transmitted to the security module.

The peripheral device connected to the security module may be at least a card reader or a chip reader or an RFID reader or an IR receiver or an HF receiver or a probe or an interface module or a trouble alarm or a sabotage alarm or a microphone or a keyboard or a camera or an alarm system.

Physical events are detected with the peripheral device, like a sensor, but they are already preprocessed and analyzed, and the analyzed data are then transmitted to the security module. Electric, magnetic, electromagnetic or mechanical actions may also be triggered by a peripheral device.

The wake-up command may comprise a code analyzable by the control receiver.

There is therefore the possibility of sending wake-up commands of varying content that is secure from manipulation, with different sources and different destinations.

Thus the code may carry source information of the control transmitter of the transmitting security module or the sensor or the peripheral device. Control receivers may thus determine the source of the wake-up command and may decide whether or not the wake-up command is relevant for them on the basis of the source and, if necessary, perform actions that depend on the source.

In addition, the code may carry at least event information of the triggering local event of the transmitting security module or the sensor or the peripheral device.

This permits further differentiation of the type of events and the resulting actions.

Furthermore, the code may carry at least address information of the receiving security module to which the wake-up command is directed.

Therefore, the execution of the wake-up command can be limited via the address information to only those security modules to which the wake-up command is directed while other security modules can ignore the wake-up command.

The transmission link may consist of the network itself or a component of the network or a databus or a signal line or a line used for the power supply or a separate medium.

When using the network itself, it is possible to access the infrastructure of the network. However, since the wake-up command has a much lower information density than the data communication, simpler energy-saving interface modules may be used or existing interface modules may be operated in a modified energy-saving mode.

One component of the network may be, for example, individual strands of a network cable.

A databus may also be equipped with simple and energy-saving interfaces because of the simple information to be transmitted.

A signal line may be a telecommunications line or a doorbell line or a door opener line.

The line used for the power supply may be the line over which the security modules are supplied with power from the conventional power supply network or are supplied with operating voltage directly. If the operating voltage is usually 12 volt d.c. voltage, the wake-up signal may be modulated as a coded alternating voltage onto the strand carrying the operating voltage.

When there is a separate medium, it may be a separate line or a wireless transmission link. In all cases, only a low data rate and a low volume of information need be transmitted for the transmission of the wake-up command, so the energy consumption for this is low.

In addition to the interface modules of the security modules or sensors or peripheral devices, the control transmitter and the control receiver may be provided, data being transmitted by the security modules or sensors or peripheral devices connected to the network thereby.

The transmission paths for transmitting wake-up commands are therefore executed separately with respect to the transmission paths of the data and may thus be designed optimally for the low data rate, data volume and energy demand.

The security module may comprise an emergency or auxiliary power source.

It is therefore possible to maintain the operating mode even in the event of failure of a central power supply. In the case of an auxiliary power source, a short-term peak power demand, e.g., for operation of an actuator, in particular a door opener, may also be made available without having to design the regular power supply network to accommodate this peak demand. Instead of using a conventional power supply network, it is thus also possible to transmit the power over other media, e.g., via the network or a databus or to generate the power autarchically via solar cells, fuel cells or similar generators.

Similarly, the sensor and/or the peripheral device may also comprise an emergency or auxiliary power source.

In addition, there is the possibility that the emergency or auxiliary power source may be chargeable or rechargeable in the energy-saving mode or in the operating mode by a central power source via the network or a databus or a separate medium.

In this way, it is also possible to omit a conventional power supply network and to supply power to the emergency or auxiliary power source by another route.

The emergency or auxiliary power source may be activatable by a local event or an idle command generated by the first local event or an idle command transmitted from another security module.

This feature makes it possible to either temporarily disconnect the central power supply to the security modules or, in the event of failure of the central power supply, to activate the emergency and auxiliary power source(s) to bridge a failure of the central power (supply) without any negative effect on operation.

An RFID detection circuit by means of which the presence of an RFID data medium within the reading area of one or more transceivers is detectable by analysis of a field damping, and by which a reading operation can be activated on detection, may be provided in a peripheral device designed as an RFID reader.

This requires only a small amount of energy for a read standby mode of the transceiver because an energy-intensive reading operation need not be triggered in the absence of detection of RFID data media.

The invention will be explained in greater detail below on the basis of exemplary embodiments, which are depicted in the drawing, in which:

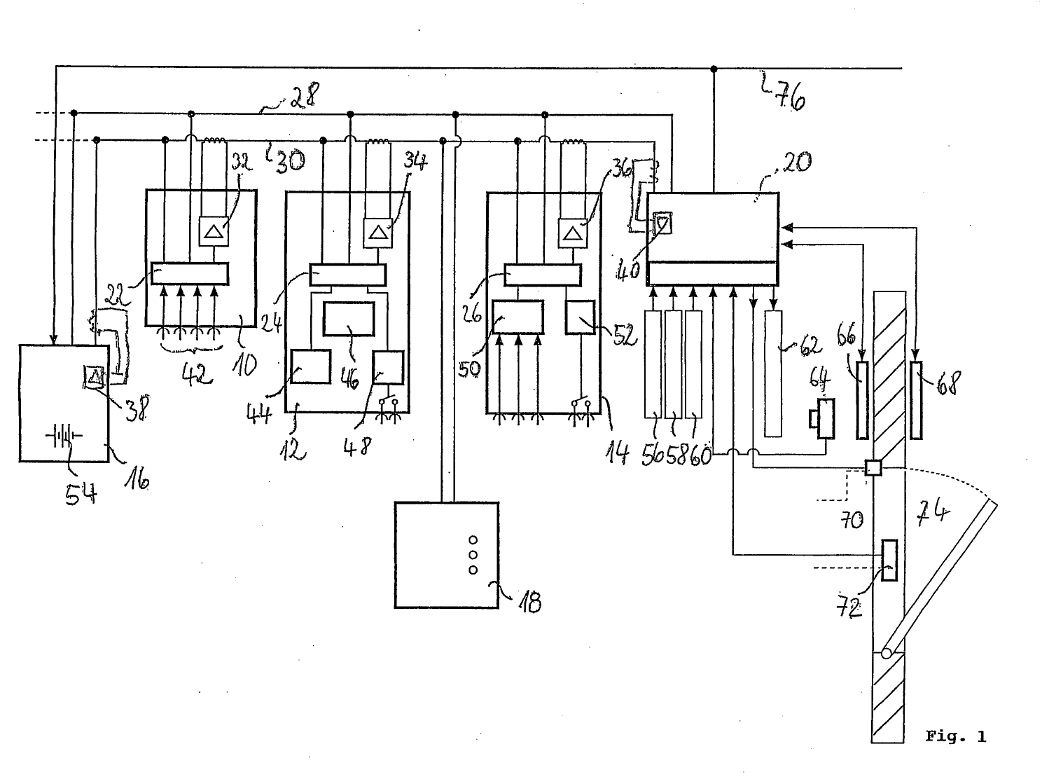

FIG. 1 shows a block diagram of a security system having multiple security modules,

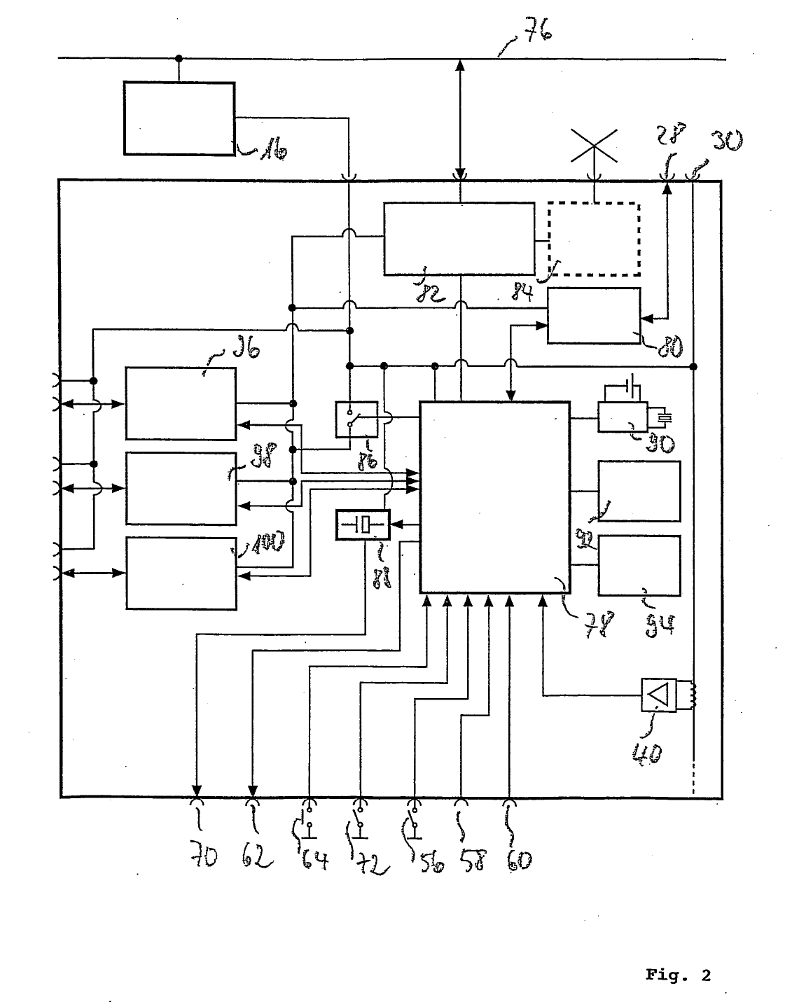

FIG. 2 shows a block diagram of a central door security system as a detail of a security module from FIG. 1,

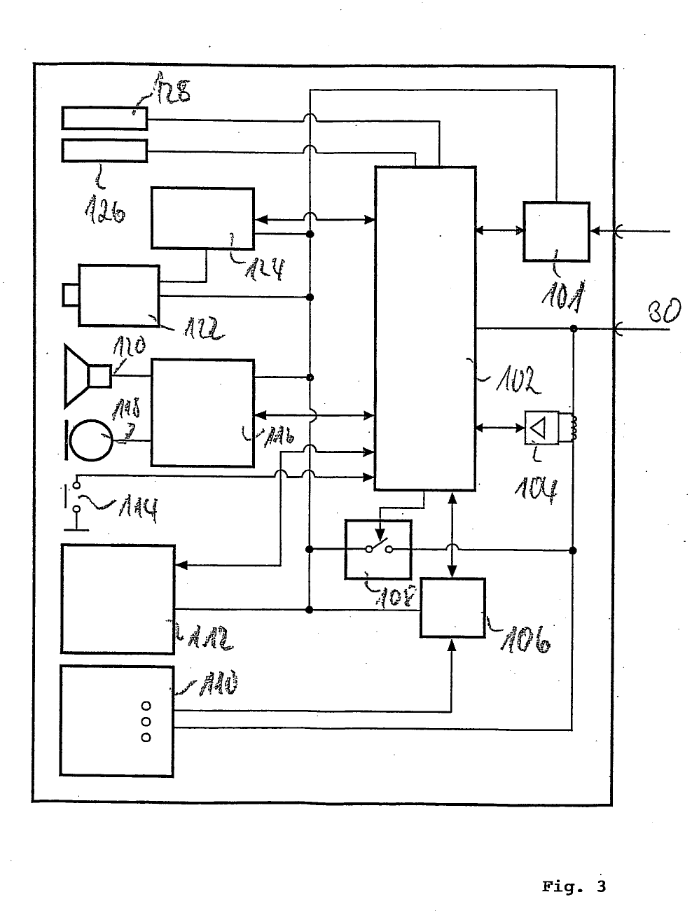

FIG. 3 shows a block diagram of a user communications module as a peripheral device and

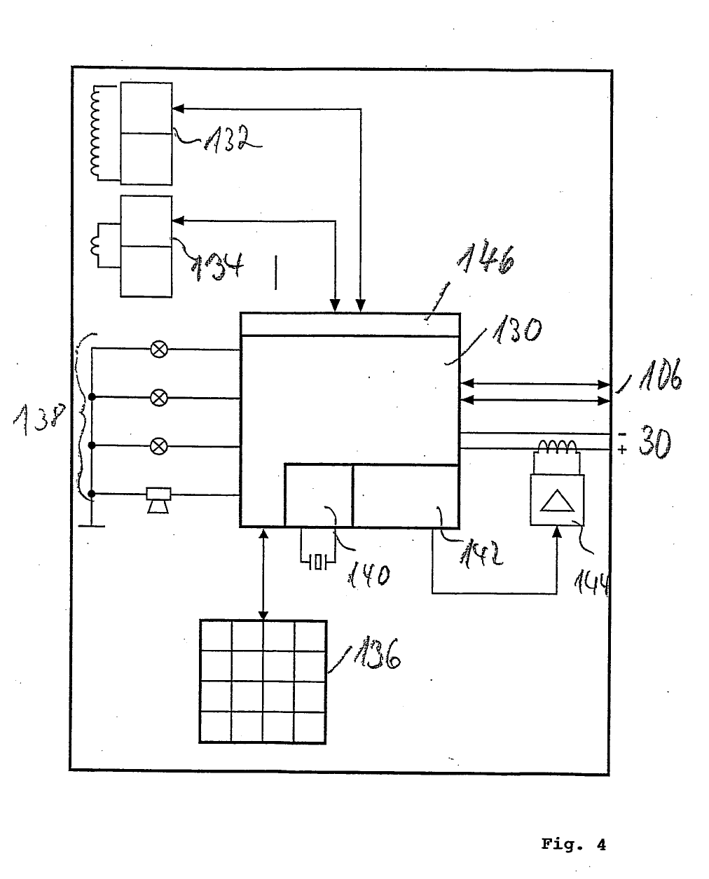

FIG. 4 shows a block diagram of a reader as a peripheral device.

FIG. 1 shows a block diagram of a security system having multiple security modules 10, 12, 14, 16, 18, 20. Each of the security modules 10, 12, 14 has a controller 22, 24, 26, which in turn consists of a processor, the respective memories and an interface module for a databus or a network. The security modules 10, 12, 14, 16, 18, 20 are connected to a databus or a network, namely here to a local bus 28, and can exchange data via the local bus 28. External or internal sensors or peripheral devices can be connected or are connected via additional inputs or interfaces of the respective controller 22, 24, 26.

Energy-intensive components of the security modules 10, 12, 14, 16, 18, 20, e.g., the processor or the interface module to the databus or network can be switched between an energy-saving mode and an operating mode. In the operating mode, all the components of the security module 10, 12, 14, 16, 18, 20 are active during conveyance and are thus able to detect, analyze and optionally forward the data supplied to them or to take action. In the energy-saving mode, however, energy-intensive components of the security module 10, 12, 14, 16, 18, 20 are switched to an idle mode or shut down completely. In the case of a processor, for example, this may happen by reducing the clock frequency is reduced or the clock is completely shut down, while the operating system and the application program are kept on standby in the loaded state in a working memory.

The interface module may also be put in an energy-saving mode by not participating actively in the data traffic over the databus or by having the network participate or be shut down completely.

Through a wake-up signal, the processor may then be cycled again at the conventional clock frequency and the program continued without having to load the files of the operating system or the application program anew or thereafter. The interface module may be returned to the operating mode by the wake-up signal.

The security module 10, 12, 14, 16, 18, 20 may be switched from the operating mode into the energy-saving mode by a local event or by an idle command triggered by a local event or an idle command transmitted from another security module via the local bus 28. The corresponding information can be transmitted here via the local bus 28 in the usual manner because the interface module and the processor are both still active at the point in time of the transmission of the idle command.

Whereas a security module can be triggered into the operating mode by a local event directly or by a wake-up command transmitted by sensors or peripheral devices, reception of a wake-up command from other security modules via the local bus 28 is impossible because their interface modules or processors are in the energy-saving mode.

To nevertheless transmit a wake-up command, the security modules 10, 12, 14, 16 are connected to the central security module 20 via a transmission link comprising the additional transmitters 32, 34, 36, 38 and a receiver 40. In the present case, the transmission link is a low-voltage line 30 that serves to supply power centrally to the security modules and whose one phase or strand is modulated with the wake-up signal. This transmission link as well as the transmitters 32, 34, 36, 38 and the receiver 40 are designed only for a low data transmission rate and data volume because only a wake-up command need be transmitted. For this reason, the transmitters 32, 34, 36, 38 and receiver 40 may be designed in a very energy-saving manner in combination with the selected transmission path. In transmitting a wake-up command via the additional transmission path, the central security module 20 is converted from the energy-saving mode into the operating mode and can then receive or continue data traffic over the local bus 28 and can ultimately communicate with the local or global network 76.

In the diagram according to FIG. 1, the first security module 10 has several inputs 42 for external sensors or peripheral devices. These may be fire sensors and alarms. The second security module 12 comprises internal sensors 44, 46 that are designed as temperature and humidity sensors and an actuator 48 for triggering an external action, e.g., turning on the lighting or an alarm. A third security module 14 forms an access module for a door with interfaces 50, 52 for incoming and outgoing signals.

A fourth security module 16 is an intelligent emergency power supply with a battery 54. The intelligent emergency power supply monitors a central power supply which is provided here from a local or global network 76. However, only a limited power of 12 watts is available here. With short-term increased demand or in the event of a failure of the central power supply, the intelligent emergency power supply takes over the power supply to the security modules 10, 12, 14, 18 and 20 from the battery 54 without interruption. On occurrence of the event “failure of the central power supply” an idle command or the charge state of the battery or other technical parameters are transmitted to the security module 20 via the transmitter 38.

A fifth security module 18 is a reader, as illustrated in detail in FIG. 4 and described in conjunction therewith.

A sixth security module 20 is formed by a central door security system, as illustrated in detail in FIG. 2. In addition, this also shows the sensors and peripheral devices provided in conjunction with access control for a door 74 and for monitoring the environment. A user communications module 68 arranged in the outer insecure area, as illustrated in detail in FIG. 3, a reader 66 for proof of authorization, arranged in the internal secure area, or, as an alternative, a door opening button 64 as well as a door sensor 72 and a door buzzer 70 are provided for the door 74.

For monitoring the environment, a sabotage contact 56, an alarm generator 58 and a fire alarm 60 are assigned to the inputs and an actuator 62 for turning on the lighting is assigned to an output as an example.

In addition to the intelligent emergency power supply, only the sixth security module 20 is connected to the local or global network 76 for the purpose of data communication. The cost-intensive and circuitry-intensive measures to prevent transfer and propagation of interference signals are thus limited in connection of modules to network cables. In addition, only one IP address is needed to identify the entire system unambiguously.

FIG. 2 shows as the security module 20 a central door security system comprising a high-performance processor 78, an interface module 80 for the local bus 28, an interface module 82 for a local or global network 76, alternatively an interface module 84 for a wireless network, interface modules 96, 98 and 100 for peripheral devices, a receiver 40 for coded wake-up signals, a battery-supported clock 90, a data memory 92 and an exchangeable backup memory 94. Due to the battery-supported clock 90, the current time with which authorization queries are checked or data are linked in acquisition and storage remains available even when other components are switched off in energy-saving mode.

Due to an idle command which may be triggered, e.g., in a time-controlled manner, the interface modules 80 for the local bus and 82 for the local or global network as well as alternatively the wireless interface module 84 and the interface modules 96, 98 and 100 for peripheral devices are shut down by means of a switch 86. The high-performance processor 78 itself is put in an energy-saving mode. Through activity of the input 64 for the door button, the input 72 for the door sensor, the input 56 for a sabotage contact, the input 58 for an alarm and the input 60 for a fire alarm, the high-performance processor can be awakened directly and switched back to operating mode, whereupon the interface modules 80, 82, 84, 96, 98 and 100 are switched back to an operating state in that the switch 68 restores the respective power supply.

In addition, the high-performance processor 78 can receive a coded wake-up signal via the receiver 40 and can thereby switch back to an operating mode indirectly. The power supply is usually provided via the power supply line 30 or, in the event of failure of the power supply, via the intelligent emergency power supply 16. Peripheral devices of a building management system, e.g., a lighting system can be activated via an output 62 and a door buzzer can be activated via an output 70. To provide the peak current for the latter, a temporary memory 88 in the form of a capacitor, which can supply a higher peak voltage than that already made available via the regular power supply 30 or the emergency power supply of the intelligent emergency power supply 16 may be provided.

Authorization data or queries for authorization via the interfaces 96, 98 and 100 can be stored in database memory 92 and also transferred to the replaceable backup memory 94 as needed, e.g., in the event of a power failure, so that these data are also available for subsequent checks.

The abovementioned interface module 100 is a connection via an RF 422 interface to a peripheral device in the form of a user communications module, whereby the interface module 100 must be designed to be especially fast because of the complex transmission of access data, audio data and image data as well as additional building data. FIG. 3 shows a user communications module connected to the input and output of this interface module 100.

The user communications module comprises a controller 102, which communicates via the interface module 101 with the central door security system from FIG. 2 via its interface module 100. Via a receiver 104 of the controller 102 can also be put in an energy-saving mode by an idle command and in an operating mode by a wake-up command.

A reader 110 is connected to the controller 102 via an interface module 106. Furthermore, a display device in the form of a contact-sensitive display screen 112, pushbutton 114 for a request to talk, a coder/decoder module 116 with a microphone 118 and a loudspeaker 120 for bidirectional speech communication, a coder 124 for stationary images and moving images with a camera 122 and a humidity sensor 126 and a temperature sensor 128 are all connected to the controller 102.

The energy-intensive peripheral modules, namely the interface module 106, the display unit 112, the coder/decoder module 116 and the coder module 124 with the camera 122 can be separated from the power supply by a switch 108 in an energy-saving mode and connected back to the power supply in an operating mode. However, the humidity sensor and the temperature sensor are constantly connected. The reader 110 for reading authorization instructions is constantly connected to a power supply to be able to read the proof of authorization in the reading area. For the case when a proof of authorization is inserted into the reading area and the energy-intensive peripheral modules of the user communications module are in energy-saving mode, a wake-up signal can be transmitted from the reader 110 to the receiver 104, putting the controller 102 in an operating mode and supplying all the shutdown peripheral devices with power again via the switch 108 and thereby putting them in the operating mode.

The controller links incoming and outgoing signals of a variety of types, namely reading data from the reader 110, display data or input data from the display/input device 112, speech data from the coder/decoder 116, image data from the coder 124 and humidity and temperature data from the sensor 126 and 128, to a complex signal, which can be transmitted to the central door security system via the high-speed interface module 100 and vice versa.

Finally, FIG. 4 shows a detailed diagram of a reader like that depicted in FIG. 1 with reference numeral 18 and in FIG. 3 with reference numeral 110.

The reader comprises a controller 130, which exchanges data via an interface module 106 according to FIG. 3 or via interface modules 96 and 98 according to FIG. 2. Power is supplied via terminals 30. Two transceivers with reading antennas are connected to the controller 130, namely a first transceiver 132 with a carrier frequency of 125 kHz and a second transceiver 134 with a carrier frequency of 13.56 MHz. The two transceivers 132 and 134 are operated in multiplex mode and can detect authorization data of different standards. In the simplest case, the controller 130 is limited to merely receiving raw data of the authorization data and relaying it in coded form, if necessary, via the interface module 106. A keyboard 136 for optional supplementary data input and a display unit 138 consisting of multiple light-emitting diodes for different reading states and a signal generator are additionally assigned to the controller 130. The controller is cycled via an internal timer 140 and can thus in turn activate the transceivers 132 and 134 in an energy-saving mode but always just for a short period of time.

Alternatively or additionally, it is possible by means of an RFID detection circuit 146 to monitor whether an RFID data medium has been brought into the reading area of the transceiver 132 or 134. This can take place jointly for the two transceivers 132 or 134 by evaluation of a field damping. In this way, only a small amount of energy is required for reading standby mode.

In the case when data are input via the transceiver 132 or the transceiver 134 or via the keypad 136 and other analyzers, in particular security modules connected to the reader are in energy-saving mode, then a coded wake-up signal is generated via a code generator 142 and transmitted via the transmitter 144 to one or more other connected security modules, so that they are put in an operating mode and are able to evaluate the authorization data that have been read or input. Wake-up signals can also initially put a security module into operating mode and this security module then in turn transmits a wake-up signal to one or more additional security modules, thereby yielding a cascaded wake-up.

1. A security system, comprising at least two security modules connected to a network and transmitting data over the network, wherein at least one of the security modules can be switched into an energy-saving mode by a first local event or an idle command generated by the first local event or an idle command transmitted from another security module and then switched to an operating mode by a second local event or a wake-up command generated by the second local event or a wake-up command transmitted from another security module.

2. The security system according to claim 1, wherein the first local event is a data inactivity or a disturbance in the power supply or a first time event.

3. The security system according to claim 1, wherein the idle command transmitted by another security module is generated by a first local event of the other security module.

4. The security system according to claim 1, wherein the second local event is an activity of a sensor or a peripheral device connected to the security module or a data activity or a normalization of the power supply or a second time event.

5. The security system according to claim 4, wherein in the case of a sensor or a peripheral device set up at a distance from the security module for transmitting a wake-up command from the sensor or the peripheral device to the security module, the sensor the peripheral device and the security module comprise a transmission link having at least one control transmitter and at least one control receiver.

6. The security system according to claim 1, wherein the wake-up command transmitted by another security module is generated by a second local event of the other security module.

7. The security system according to claim 1, wherein the security modules comprise a transmission link having at least one control transmitter and at least one control receiver for transmitting the wake-up command from one security module to the other.

8. The security system according to claim 4, wherein the sensor comprises at least one motion sensor or electrostatic sensor or capacitive sensor or magnetic sensor or electromagnetic sensor or voltage sensor or current sensor or radar sensor or pressure sensor or acceleration sensor or proximity sensor or optical sensor or acoustic sensor or thermal sensor or humidity sensor or biometric sensor or gas sensor or fire sensor or smoke sensor or glass breakage sensor or Hall sensor or reed sensor or switch.

9. The security system according to claim 4, wherein the peripheral device comprises at least one card reader or chip reader or RFID reader or IR receiver or HF receiver or pushbutton or interface module or trouble alarm or sabotage alarm or microphone or keypad or camera or alarm system.

10. The security system according to claim 1, wherein the wake-up command comprises a code that can be analyzed by the control receiver.

11. The security system according to claim 10, wherein the code carries source information of the control transmitter of the transmitting security module or the sensor or the peripheral device.

12. The security system according to claim 10, wherein the code carries at least event information of the triggering local event of the transmitting security module or the sensor or the peripheral device.

13. The security system according to claim 10, wherein the code carries at least address information of the receiving security module to which the wake-up command is directed.

14. The security system according to claim 5, wherein the transmission link comprises the network itself or a component of the network or a databus or a separate medium.

15. The security system according to claim 5, wherein the control transmitter and the control receiver are provided in addition to interface modules of the security modules or sensors or peripheral devices over which data are transmitted by the security modules or sensors or peripheral devices connected to the network.

16. The security system according to claim 1, wherein the security module comprises an emergency or auxiliary power source.

17. The security system according to claim 1, wherein the sensor comprises an emergency or auxiliary power source.

18. The security system according to claim 1, wherein the peripheral device comprises an emergency or auxiliary power source.

19. The security system according to claim 16, wherein the emergency auxiliary power source can be charged or recharged in the energy-saving mode or in the operating mode by a central power source via the network or a databus or a separate medium.

20. The security system according to claim 16, wherein the emergency or auxiliary power source can be switched by the first local event or an idle command generated by the first local event or an idle command transmitted by another security module.

21. The security system according to claim 8, wherein in a peripheral device designed as an RFID reader, an RFID detection circuit is provided, by means of which the presence of an RFID data medium can be detected by evaluation of a field damping.

22. The security system according to claim 21, wherein several transceivers having different frequencies are assigned to the same RFID detection circuit.
